(19) United States
(12) Patent Application Publication
(10) Pub. No.: US 2013/0101775 A1
(43) Pub. Date: Apr. 25, 2013

(54) MULTILAYER FILM

(71) Applicants: Kathleen A. Dennison, Grant Township, MN (US); Bruce A. Nerad, Oakdale, MN (US); David J. Yarusso, Shoreview, MN (US); John A. Nielsen, Woodbury, MN (US)

(72) Inventors: Kathleen A. Dennison, Grant Township, MN (US); Bruce A. Nerad, Oakdale, MN (US); David J. Yarusso, Shoreview, MN (US); John A. Nielsen, Woodbury, MN (US)

(21) Appl. No.: 13/521,889

(22) PCT Filed: Jan. 20, 2011
(86) PCT No.: PCT/US2011/021853

§ 371 Date: Jan. 7, 2013

Related U.S. Application Data
(60) Provisional application No. 61/296,936, filed on Jan. 21, 2010.

(51) Int. Cl. B32B 27/08; B32B 27/40; C09J 7/02

(52) U.S. Cl. CPC B32B 27/08; C09J 7/02; C09J 7/0225; B32B 27/40
USPC 428/41.3; 428/423.1; 428/354; 428/41.8

(57) ABSTRACT

The present application is directed to a multilayer film The film comprises a thermoplastic receptor layer comprising a polyurethane, a thermoplastic core layer on the receptor layer comprising an acidic group or an anhydride group, and a thermoplastic primer layer on the core layer opposite the receptor layer comprising a nitrogen containing polymer. In some embodiments, the multilayer film includes additional layers. For example, an adhesive layer may be on the primer layer opposite the core layer. In another embodiment, a release layer is on the adhesive layer opposite the primer layer. In another embodiment, a liner layer is on the release layer opposite the adhesive layer.

### FIELD

The present application is directed to multilayer films. Such films may be useful, for example, as graphic articles.

### BACKGROUND

Graphic films are used for example to apply designs, e.g. images, graphics, text and/or information, on windows, buildings, pavements or vehicles such as autos, vans, buses, trucks, streetcars and the like for e.g. advertising or decorative purposes.

### SUMMARY

The present application is directed to a multilayer film. The film comprises a thermoplastic receptor layer comprising a polyurethane, a thermoplastic core layer on the receptor layer comprising an acidic group or an anhydride group, and a thermoplastic primer layer on the core layer opposite the receptor layer comprising a nitrogen containing polymer.

In some embodiments, the multilayer film includes additional layers. For example, an adhesive layer may be on the primer layer opposite the core layer. In another embodiment, a release layer is on the adhesive layer opposite the primer layer. In another embodiment, a liner layer is on the release layer opposite the adhesive layer.

### BRIEF DESCRIPTION OF THE DRAWINGS

FIG. 1 is an elevated view of a first embodiment of the application.

FIG. 2 is an elevated view of a second embodiment of the application.

### DETAILED DESCRIPTION

The present application is directed to a multilayer film. Such multilayer films are useful as graphic films, labels and other communication films. Additional uses include films used as electronically-cut marking films, surface protection films, graphic protection films and antigraffiti films.

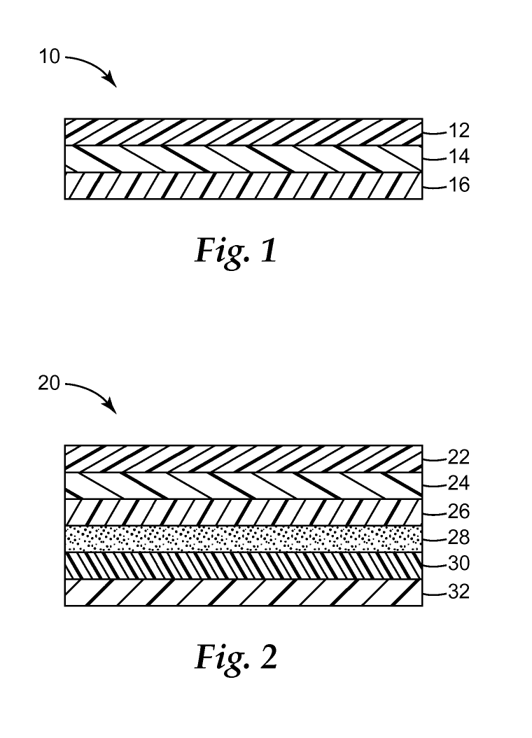

FIG. 1 shows a first embodiment of the present application. Multilayer film 10 comprises a receptor layer 12. Receptor layer 12 is on core layer 14 and a primer layer 16 is on the core layer 14, opposite the receptor layer 12.

FIG. 2 shows a second embodiment of the present application. Multilayer film 20 comprises a receptor layer 22. Receptor layer 22 is on core layer 24 and a primer layer 26 is on the core layer 24, opposite the receptor layer 22. The multilayer film 20 additionally includes an adhesive layer 28 on the primer layer 26 opposite the core layer 24. The multilayer film 20 additionally includes a release layer 30 on the adhesive layer 28 opposite the primer layer 26. The multilayer film 20 additionally includes a liner layer 32 on the release layer 30 opposite the adhesive layer 28. In many embodiments, the multilayer film can be separated along the interface between the adhesive layer 28 and the release layer 30.

The multilayer film comprises a receptor layer. The receptor layer is generally useful for receiving an image, for example an ink jetted image. In some embodiments, the receptor layer is a layer that is receptive to solvent-based inkjet ink. In other embodiments, the receptor layer is receptive to UV curable inkjet inks Additionally, in some embodiments, the receptor layer is receptive to both. The receptor layer is generally a thermoplastic material. In some embodiments, the receptor layer comprises a polyurethane. Polyurethanes useful in the receptor layer include, for example, those sold under the tradenames Desmopan 2590A and Texin DP7-3044 available from Bayer A. G.; Irogran CAl 16-201 and Krystalgran PN03-217, available from Hunstman International, LLC; Estane 58277 and Estane 58219, available from The Lubrizol Corp., and blends thereof.

The multilayer film comprises a thermoplastic core layer on the receptor layer. The thermoplastic core layer comprises an acidic group, an anhydride group, or a combination thereof. The core layer is most commonly white and opaque for graphic display applications, but could also be transparent, colored translucent, or colored opaque. The core layer can comprise any polymer having desirable physical properties for the intended application. Flexibility or stiffness, durability, tear resistance, conformability to non-uniform surfaces, die cuttability, weatherability, solvent resistance, heat resistance and elasticity are examples of properties which may be offered by this layer. For example, a graphic marking film used in short term outdoor promotional displays typically can withstand outdoor conditions for a period in the range from about 3 months to about one year or more and exhibits tear resistance and durability for easy application and removal.

The core layer may be multilayer. In such multilayer embodiments, the layers in contact with the receptor layer and the primer layer comprise an acidic group, an anhydride group or a combination thereof

Materials useful in the core layer include, for example, those sold under the tradenames Primacor 1410 and Amplify GR resins, available from Dow Chemical Company; Orevac 18722, available from Arkema, Inc.; Bynel series 4000 resins, available from E. I. duPont deNemours and Co. The core layer may comprise additional non-functional polymers in a blend, for example high density polyethylene, low density polyethylene, or polypropylene.

The multilayer film comprises a thermoplastic primer layer on the core layer opposite the receptor layer. The primer layer comprises a nitrogen containing polymer. In some embodiments, the primer layer comprises a polyurethane. Polyurethanes useful in the primer layer include, for example, those sold under the tradnames Desmopan 2590A and Texin DP7-3044 available from Bayer A. G.; Irogran CA116-201 and Krystalgran PN03-217, available from Hunstman International, LLC; Estane 58277 and Estane 58219, available from The Lubrizol Corp., and blends thereof.

In other embodiments, the primer layer comprises a polyamide. Polyamides useful in the primer layer include those sold under the tradename Pebax, available from Arkema, Inc.

The multilayer film may comprise an adhesive layer on the primer layer opposite the core layer. The adhesive layer generally comprises a thermoplastic acrylic polymer. In some embodiments, the adhesive comprises an acid functional acrylic. In some embodiments, the acid functional acrylic polymer comprises, for example, about 10% acid such as acrylic acid.

In certain embodiments, the adhesive is extruded. Generally the adhesive is a pressure sensitive adhesive after cooling. Furthermore, the pressure sensitive adhesive component can be a single pressure sensitive adhesive or the pressure sensitive adhesive can be a combination of two or more pressure sensitive adhesives.

The pressure sensitive adhesive may be inherently tacky. If desired, tackifiers may be added to a base material to form the pressure sensitive adhesive. Useful tackifiers include, for example, rosin ester resins, aromatic hydrocarbon resins, aliphatic hydrocarbon resins, and terpene resins. Other materials can be added for special purposes, including, for example, oils, plasticizers, antioxidants, ultraviolet (“UV”) stabilizers, pigments, and curing agents.

Specific examples of suitable adhesive include acrylic acid containing pressure sensitive adhesives, such as those disclosed in attorney Docket Number 66099US002, WO 2002/081586 and U.S. Pat. No. 6,294,249, incorporated by reference herein.

The multilayer film may comprise a release layer on the adhesive layer opposite the primer layer. The release layer generally comprises a thermoplastic polymer. The release layer comprises a release agent. The release layer may also comprise other polymers, blended with the release agent. In some embodiments, the release layer comprises a plastomer as a release agent.

In the present application, the plastomer release agent is a copolymer of ethylene and alpha-olefins having from 3 to about 10 carbon atoms and density no greater than 0.91 g/cc. Suitable alpha-olefins include 1-butene, 1-hexene, 1-octene, and combinations thereof. Copolymers of ethylene and 1-octene are preferred for use with acrylate-based pressure sensitive adhesives. The copolymers may be either block copolymers or non-block copolymers. In some embodiments, the copolymer has a density of no greater than 0.91 g/cc, for some examples no greater than 0.89 g/cc. Suitable copolymers are commercially available from Dow Chemical Company, Midland, Mich., under the INFUSE tradename and from ExxonMobil Chemical Company, Houston, Tex., under the EXACT tradename. In some embodiments, the copolymer is polyolefin polymer made using a metallocene catalyst.

As stated above, the release agent may additionally be blended with other polymers to form the release layer. Examples of the polymers useful for blending with the release agent include other polyolefin polymers having a density of no greater than 0.91 g/cc; polyethylene (including low density polyethylene), polydiorganosiloxane polyoxamide copolymers, polypropylene and those polymers sold under the trade names Bynel and Nucrel available from E. I. du Pont de Nemours and Company, Moplen HL 456J available from LyondellBasell Industries, Vistamaxx available from ExxonMobil Corporation, and combinations thereof.

Suitable release agents include, for example, those disclosed in Attorney Docket Number 65043W0003 (PCT Application Number US2009/068632) and in Attorney Docket Number 64700W0003 (PCT Application Number US2009/054322) incorporated herein by reference.

The multilayer film may comprise a liner layer on the release layer opposite the adhesive layer. The liner layer may be a paper liner or a polymer liner and may be multilayer. The release liner generally comprises a thermoplastic polymer. In some embodiments, the liner layer comprises a polyolefin. Examples of the polyolefin include high density polyethylene, low density polyethylene, and polypropylene. In other embodiments, the liner comprises styrene polymers and copolymers.

Any of the layers in the multilayer film may include additives. For example, additives include pigments, fillers, ultraviolet stabilizing agents, slip agents, antiblock agents, antistatic agents, and processing aids familiar to those skilled in the art. Additives additionally include other polymers for modifying the characteristics of the layer, for example high density polyethylene, low density polyethylene and polypropylene.

The multilayer film of the present application may be manufactured using any known method.

Coextrusion is a known method of manufacturing films. Coextrusion means, for the present application, the simultaneous melt processing of multiple molten streams and the combination of such molten streams into a single unified structure, or coextruded film, for example from a single extrusion die. Adhesive articles have been manufactured with extrusion technology as shown, for example, in U.S. Pat. No. 5,660,922 (coextruding double sided adhesive tapes) and U.S. Pat. No. 6,777,053. It is also known to extrude release material blends to form a release film. See, for example, U.S. patent application 2004-0127121.

The process is run generally by processing the feedstocks at or above their melt temperature through the die, resulting in the coextruded film. A coextruded film is generally a composite of all the molten feedstocks placed within the co-extrusion process. The resulting co-extruded films are generally multilayer. The layers are in contact with one another in the molten state. In certain embodiments, the layers are in contact throughout the extrusion, for example they are in contact within the die.

Alternatively, the multilayer film may be manufactured by consecutive in-line extrusion, wherein a layer is extruded onto the stack one at a time, or any combination of coextrusion and in-line extrusion. The multilayer film may additionally be manufactured by laminating the layers together as is known in the art. Additionally, the multilayer film may be manufactured by any combination of coextrusion, in-line extrusion, and lamination.

The coextruded film may further be processed, for example by orientation. One example of orientation of a film is biaxial orientation. Biaxial orientation involves stretching the film in two directions perpendicular to each other, generally in the down-web direction and cross-web direction. In a typical operation, the freshly extruded molten film is fed onto a chill roll to produce a quenched amorphous film which is briefly heated and stretched in the down-web direction, and then conducted through a tenter frame where it is stretched transversely with moderate heating. Down-web direction stretching may be accomplished by passing between two sets of nip rolls, the second set rotating at a higher speed than the first.

### EXAMPLES

These examples are merely for illustrative purposes only and are not meant to be limiting on the scope of the appended claims. All parts, percentages, ratios, etc. in the examples and the rest of the specification are by weight, unless noted otherwise.

### Example 1

A multilayer film was prepared by coextruding the following layers:

1. a first liner layer made of a layer of of 0.5 mil of low density polyethylene (LDPE) (available under the tradename LDPE 640i from Dow Chemical Co.) and a layer of 3.5 mil high density polyethylene (HDPE) (available under the tradename Unival DMDH 6400 NT7 from Dow Chemical Co.),

2. a second release layer of 0.5 mil plastomer (available under the tradename INFUSE Olefin Block Copolymer 9507 from Dow Chemical Co. and blended with 2% PolyOne CC10121543WE Red Pigment masterbatch),

3. a third adhesive layer of 0.45 mil of a pressure sensitive adhesive. The adhesive was prepared by melt blending two polymers, each of which was produced by bulk polymerization within a polymeric pouch initiated by ultraviolet radiation according to the methods described in W09607522. The first polymer was prepared from a mixture of 90 parts by weight 2-ethyl hexyl acrylate and 10 parts of acrylic acid. The second polymer was prepared from a mixture of 75 parts 2-ethyl hexyl acrylate, 15 parts methyl acrylate, and 10 parts N,N-dimethyl acrylamide. The blend consisted of equal parts of the first polymer and the second polymer,

4. a fourth primer layer of 0.2 mil polyether-block-amide-containing blend (49% polymer available under the tradename Pebax 2533 from Arkema, Inc./49% HDPE/2% PolyOne Oncolor 4900 CMB Black CC00015660DR Black Pigment Masterbatch),

5. a fifth core layer comprising 2.75 mils of a maleated polyethylene-containing polymer blend (40% HDPE/40% polymer available under the tradename Amplify™ GR205 from Dow Chemical Co./20% PolyOne 15077 White CC00038580 White Pigment Masterbatch),

6. and a sixth receptor layer comprising a urethane-based receptor blend (36% polymer available under the tradename Krystalgran PN03-217 from Huntsman International/36% polymer available under the tradename Irogran CAl 16-201 from Huntsman International/20% Ampacet White COP MB 110847/8% polymer available under the tradename Amplify™ GR205 from Dow Chemical Co.).

The film was printed with an inkjet printer (VUTEk 150 printer). The film could be easily separated between layers 2 and 3.

### Example 2

A multilayer film was prepared consisting of a first layer of 0.75 mil of a urethane-based receptor blend (34% polymer available under the tradename Krystalgran PN03-217 from Huntsman International/ 34% polymer available under the tradename Irogran CA116-201 from Huntsman International/ 20% Ampacet White COP MB 110847/8% polymer available under the tradename Amplify™ GR205 from Dow Chemical Co./4% polymer available under the tradename Avalon AO10127 Light Stabilizer from Huntsman International), a second layer consisting of 3.2 mil of a maleated polyethylene-containing polymer blend (40% HDPE/40% polymer available under the tradename Amplify™ GR205 from Dow Chemical Co./20% White Pigment Masterbatch PolyOne 15077 White CC00038580), and a third layer of 0.3 mil comprising a polyether-block-amide (50% polymer available under the tradename Pebax MX1205 from Arkema/ 50% HDPE).

A second multilayer film was prepared consisting of a first 4.1 mil layer composed of HDPE, and a second 0.5 mil layer composed of plastomer (available under the tradename INFUSE Olefin Block Copolymer 9507 from Dow Chemical Co.).

A third extrusion of adhesive (90% Isooctylacrylate/10% Acrylic acid) was coated onto a silicone-treated paper carrier at a thickness of 1 mil. The adhesive additionally contained a crosslinker and was further cured by exposure to UV light.

The adhesive layer was then laminated to the polyether-block-amide side of the first three layer coextrusion. The silicone-treated paper was then stripped from the adhesive, and the second two-layer coextrusion was laminated in its place.

The film was printed with an inkjet printer (Vutek 150 printer). The film could be easily separated between the plastomer and the adhesive.

Various modifications and alterations of the present invention will become apparent to those skilled in the art without departing from the spirit and scope of the invention.

What is claimed is:

1. A multilayer film comprising
a thermoplastic receptor layer comprising a polyurethane;
a thermoplastic core layer on the receptor layer comprising an acidic group or an anhydride group; and
a thermoplastic primer layer on the core layer opposite the receptor layer comprising a nitrogen containing polymer.

2. The film of claim 1 comprising an adhesive layer on the primer layer opposite the core layer.

3. The film of claim 2 wherein the adhesive comprises a thermoplastic polymer.

4. The film of claim 2 comprising a release layer on the adhesive layer opposite the primer layer.

5. The film of claim 4 wherein the release material comprises a thermoplastic polymer.

6. The film of claim 4 comprising a liner layer on the release layer opposite the adhesive layer.

7. The film of claim 6 wherein the liner layer comprises a thermoplastic polymer.

8. The film of claim 1 wherein the primer layer comprises a polyurethane.

9. The film of claim 1 wherein the primer layer comprises a polyamide.

10. The film of claim 2 wherein the adhesive comprises an acid functional acrylic polymer.

11. The film of claim 4 wherein the release layer comprises a plastomer.

12. The film of claim 6 wherein the liner layer comprises a polyolefin.

13. The film of claim 6 wherein the liner layer comprises a styrene polymer or copolymer.
